(19) United States
(12) Patent Application Publication
(10) Pub. No.: US 2011/0015323 A1
(43) Pub. Date: Jan. 20, 2011

(54) Polyethylene compositions comprising a polar phenolic antioxidant and reduced dissipation factor, and methods thereof

(75) Inventor: Mick C. HUNDLEY, Loveland, OH (US)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Equistar Chemicals, LP, Houston, TX (US)

(21) Appl. No.: 12/460,304

(22) Filed: Jul. 16, 2009

(51) Int. Cl. C08K 5/13; C08K 5/09

(52) U.S. Cl. 524/320; 524/323

(57) ABSTRACT

A polyethylene composition comprising about 0.0001% to less than 0.22% by weight of a polar phenolic antioxidant, the polar phenolic antioxidant comprising a polar phenolic moiety and a non-polar C₃-C₃₀ hydrocarbon moiety, wherein the polyethylene composition comprises a reduced dissipation factor versus the same polyethylene composition comprising less of the same polar phenolic antioxidant.

### FIELD OF INVENTION

The present inventive subject matter generally relates to novel polyethylene compositions comprising at least one particular class of polar phenolic antioxidants. In particular, the present subject matter generally relates to polyethylene compositions comprising at least one polar phenolic antioxidant from a particular class of polar phenolic antioxidants, wherein the polyethylene compositions comprise a reduced dissipation factor versus the same polyethylene compositions comprising less of the same polar phenolic antioxidant.

### BACKGROUND OF INVENTION

Various types of polymers and polymer blends can be used as insulating materials in the wire and cable industry. In particular, polyolefins such as high-density polyethylene (HDPE), medium-density polyethylene (MDPE), low-density polyethylene (LDPE), and linear low-density polyethylene (LLDPE) can be used singularly or in various combinations, or in combination with other polymeric materials, to form insulating materials for various types of wire and cable applications. Generally, it is held that polyethylene is a good insulating material for cable and wire applications given its affordability, as well as the very low dielectric loss associated with the molecular motions of the barefoot material. See, for example, the Electrical Wire Handbook. Guilford, Conn.: The Wire Association International, Inc., 1983, pages 89-90. In particular, the dielectric constant (k) and the dissipation factor (DF) of polyethylene insulating material are of particular importance for minimizing dielectric losses associated with the material. However, it is known that polar functional groups contained in impurities and additive compounds can negatively affect the dielectric properties of polyethylene material, and can increase the dielectric losses of the material.

In fact, the dielectric constant for polyethylene insulating materials can be affected by a number of factors, including the crystallinity and density of the material, and increases as the density of the material increases. However, the dielectric constant for polyethylene insulating materials generally can be regulated insomuch that the factors that negatively affect the dielectric constant, including for example the density and crystallinity of the material, can be tailored by altering the conditions in which the material is produced.

Similarly, the dissipation factor of polyethylene insulating materials can be affected by a number of factors, albeit generally different factors. In particular, ASTM D4872-99(2004)e1, which is a standard test method for dielectric testing of wire and cable filling compounds, states that even small amounts of contaminants, including polar compounds and polar impurities, can negatively affect the resultant wire or cable's electrical properties. In fact, it is a general rule that the greater the amount of polar material in the polyethylene insulating material, whether through impurities or additive compounds having polar functional groups, the greater the resulting dissipation factor will be for the polyethylene material, and thus, the greater the dielectric losses will be for the insulating material. Therefore, as generally noted in Electrical Losses in Coaxial Cable by R. F. Eaton and C. J. Kmiec of The Dow Chemical Company, it is desirable to minimize or completely reduce even trace amounts of additive compounds having polar functional groups and polar impurities in polyolefin insulating materials, including polyethylene insulating materials, to reduce electrical losses through an increased dissipation factor of the material.

However, polyethylene materials, including polyethylene insulating materials, generally have antioxidants incorporated therein to minimize oxidation and degradation of the material. These antioxidants are generally added to prevent various undesirable conditions, including yellowing of the material, increased odor properties, as well as to prevent the deterioration of the mechanical and physical properties of the polyethylene material. Accordingly, if the antioxidant is not added in a sufficient quantity, then the polyethylene material can oxidize and degrade prematurely. Unfortunately, most of the commonly used and most effective antioxidants for preventing oxidation and degradation in polyethylene materials are polar phenolic antioxidants. In fact, many of these antioxidants are marketed and sold by Ciba, formerly known as Ciba Specialty Chemicals Inc., including IRGANOX® 1010, IRGANOX® 1024, and IRGANOX® 1035. Therefore, there has been a long-standing paradox in the wire and cable industry—either you can add polar phenolic antioxidants in sufficient quantities to prevent premature oxidization and degradation of the polyethylene insulating material, while sacrificing electrical efficiency, or you can increase the electrical efficiency by not adding sufficient quantities of the polar phenolic antioxidants to the polyethylene material, while sacrificing the stability and operability of the material from premature oxidation and degradation.

In order to try and overcome this paradox and the deficiencies of using polar phenolic antioxidants in electrical insulating materials, International Patent Application Publication WO 2004/037909 relates to charge dissipation modifiers for olefinic interpolymer compositions. In particular, WO 2004/037909 relates to olefinic interpolymers having a dissipation modifier, wherein the dissipation modifier is selected from a particular class of amine compounds, silica compounds, and phosphoric acid. Nevertheless, the dissipation modifiers described therein not only need to be used with particular boron-containing activation packages, but the modifiers described need to be added to the interpolymer in a particular process to work properly. Additionally, phosphoric acid and amines can be hazardous, highly reactive, corrosive, and flammable, and as such, are not as convenient as polar phenolic antioxidants for inclusion in polymeric material for electrical insulation applications.

Additionally, U.S. Pat. No. 3,856,726 relates to polybutene-1 compositions for insulation for high-tension cables having a particular amount of a water-insoluble magnesium compound, and a particular amount of a phenolic antioxidant. However, the water-insoluble magnesium compound is critical to the functionality of the polybutene-1 compositions as insulation for high-tension cables, and without the magnesium compound, it is reported that only minor benefits can be produced from a myriad of different phenolic antioxidants.

Therefore, there remains a need in the art to overcome the paradox of either having to sacrifice the electrical efficiency for the thermo-oxidative chemical stability of polyethylene insulating material, or sacrificing the thermo-oxidative chemical stability of the material for electrical efficiency. In this regard, there remains a need in the art for a polyethylene composition comprising a polar phenolic antioxidant, wherein the polyethylene composition comprising the polar phenolic antioxidant comprises a reduced dissipation factor versus the same polyethylene composition comprising less of the same polar phenolic antioxidant.

### SUMMARY OF INVENTION

The present inventive subject matter generally relates to polyethylene compositions comprising at least one particular class of polar phenolic antioxidants, wherein the polyethylene compositions comprising at least one polar phenolic antioxidant from the particular class of polar phenolic antioxidants comprise a reduced dissipation factor versus the same polyethylene compositions comprising less of the same polar phenolic antioxidant. In this regard, an embodiment of the present subject matter relates to a polyethylene composition comprising about 0.0001% to less than 0.22% by weight of a polar phenolic antioxidant, the polar phenolic antioxidant comprising a polar phenolic moiety and a non-polar C₃-C₃₀ hydrocarbon moiety, wherein the polyethylene composition comprises a reduced dissipation factor versus the same polyethylene composition comprising less of the same polar phenolic antioxidant.

In yet another embodiment, the present subject matter relates to a cable or wire comprising a polyethylene composition comprising about 0.0001% to less than 0.22% by weight of a polar phenolic antioxidant, the polar phenolic antioxidant comprising a polar phenolic moiety and a non-polar C₃-C₃₀ hydrocarbon moiety, wherein the cable or wire comprises a reduced dissipation factor versus the same cable or wire comprising less of the same polar phenolic antioxidant.

Additionally, the present subject matter relates to a method for reducing the dissipation factor of a polyethylene composition comprising adding about 0.0001% to less than 0.22% by weight of a polar phenolic antioxidant to the polyethylene composition, the polar phenolic antioxidant comprising a polar phenolic moiety and a non-polar C₃-C₃₀ hydrocarbon moiety, wherein the polyethylene composition comprises a reduced dissipation factor versus the same polyethylene composition comprising less of the same polar phenolic antioxidant.

### BRIEF DESCRIPTION OF THE DRAWINGS

FIG. 1 illustrates how various polar phenolic antioxidants affect the dissipation factor of a high-density polyethylene resin at a frequency of 2 GHz.

FIG. 2 illustrates how various amounts (in ppm) of an embodiment of a polar phenolic antioxidant of the instant subject matter affects the dissipation factor of a high-density polyethylene resin at a frequency of 2 GHz.

FIG. 3 illustrates how various amounts (in ppm) of an embodiment of a polar phenolic antioxidant of the instant subject matter affects the normalized dissipation factor of a high-density polyethylene resin at a frequency of 2 GHz.

### DETAILED DESCRIPTION OF INVENTION

The present inventive subject matter generally relates to novel polyethylene compositions comprising at least one particular class of polar phenolic antioxidants, wherein the polyethylene compositions comprising at least one polar phenolic antioxidant from the particular class of polar phenolic antioxidants comprise a reduced dissipation factor versus the same polyethylene compositions comprising less of the same polar phenolic antioxidant. In particular, in preferred embodiments, the polyethylene compositions of the present subject matter not only comprise sufficient amounts of at least one polar phenolic antioxidant from a particular class of polar phenolic antioxidants to prevent premature oxidation and degradation of the polyethylene material, but contrary to previously believed standards, it has been unexpectedly found that within particular weight percent ranges, the higher the concentration is of the particular polar phenolic antioxidant, the lower the dissipation factor is for the resultant polyethylene composition, with respect to the same polyethylene composition comprising less of the same polar phenolic antioxidant.

Polar Phenolic Antioxidants:

As discussed above, contrary to custom wisdom, it has been unexpectedly found that a particular class of polar phenolic antioxidants actually decreases the dissipation factor of polyethylene insulating material as the amount is increased, within a particular weight percent range. Generally, the polar phenolic antioxidants of the present subject matter comprise a polar phenolic moiety and a non-polar C₃-C₃₀ hydrocarbon moiety.

In preferred embodiments of the present subject matter, the hydroxyl group of the phenolic moiety is in the 4-position, and the phenolic moiety can comprise up to four, preferably up to two, carbonaceous substituents. Additionally, in preferred embodiments, the non-polar C₃-C₃₀ hydrocarbon moiety of the polar phenolic antioxidant is a linear or branched C₃-C₃₀ alkyl, C₃-C₃₀ alkenyl, C₃-C₃₀ alkynyl, C₃-C₃₀ cycloalkyl group, or C₃-C₃₀ aryl group, the C₃-C₃₀ cycloalkyl group comprising a C₃-C₁₀ cycloalkyl moiety optionally comprising at least one C₁-C₂₇ substituent, and the C₃-C₃₀ aryl group comprising a C₃-C₁₀ aryl moiety optionally comprising at least one C₁-C₂₇ substituent. In particularly preferred embodiments, the non-polar C₃-C₃₀ hydrocarbon moiety of the polar phenolic antioxidant is selected from a non-polar C₈-C₂₅ hydrocarbon moiety, and the C₈-C₂₅ hydrocarbon moiety is a linear or branched C₈-C₂₅ alkyl, C₈-C₂₅ alkenyl, or C₈-C₂₅ alkynyl.

Furthermore, in particularly preferred embodiments of the present subject matter, the polar phenolic antioxidant is of formula (I):

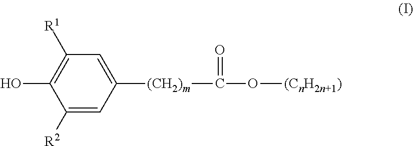

wherein:
R¹ and R² are the same or different, and are selected from linear or branched C₁-C₁₀ aliphatic groups, or C₃-C₁₀ aryl groups, the C₃-C₁₀ aryl groups optionally comprising at least one linear or branched C₁-C₁₀ aliphatic substituent; and R¹ and R² are preferably selected from a linear or branched C₁-C₁₀ alkyl, C₁-C₁₀ alkenyl, or C₁-C₁₀ alkynyl groups;
m ranges from 1 to 20, and preferably ranges from 1 to 10; and
n ranges from 3 to 30, and preferably ranges from 8 to 25. In yet another particularly preferred embodiment of the present subject matter, the polar phenolic antioxidant is octadecyl-3-(3,5-di-tert-butyl-4-hydroxyphenyl)-propionate.

Furthermore, as discussed above, it has been unexpectedly found that the aforementioned polar phenolic antioxidants actually decrease the dissipation factor of polyethylene materials as the amount is increased, within a particular weight percent range. In preferred embodiments of the present subject matter, the polar phenolic antioxidant is present in the polyethylene composition in an amount of about 0.0001% to less than 0.22% by weight. In particularly preferred embodiments, the phenolic antioxidant is present in the polyethylene composition in an amount of about 0.0005% to about 0.16% by weight, and yet in further preferred embodiments, the phenolic antioxidant is present in the polyethylene composition in an amount of about 0.02% to about 0.08% by weight.

Polyethylene Compositions:

Various types of polyethylene compositions are suitable for use in the present subject matter. In general, non-limiting examples of polyethylene compositions useful in the present subject matter include high-density polyethylene, medium-density polyethylene, low-density polyethylene, linear low-density polyethylene, and mixtures thereof. In particularly preferred embodiments, the polyethylene compositions are high-density polyethylene, low-density polyethylene, including high-pressure low-density polyethylene, linear low-density polyethylene, and mixtures thereof, with the high-density polyethylene and low-density polyethylene optionally comprising up to 10% by weight of a comonomer, and the linear low-density polyethylene optionally comprising up to 20% by weight of a comonomer. The comonomer for the high-density polyethylene, low-density polyethylene, and linear low-density polyethylene can be selected from C₃-C₁₀ α-olefins, preferably C₃-C₆ α-olefins, including but not limited to propylene, butene-1, hexene-1, and octene-1.

Additionally, the high-density polyethylene can have a melt index (MI) according to ASTM D 1238, condition E (190° C. at 2.16 kg) ranging from 0.01 to 20 g/10 min., and preferably ranges from about 1 to 10 g/10 min, as well as can have a density according to ASTM D 1505 equal to or greater than 0.941 g/cm³, and preferably can be equal to or greater than 0.950 g/cm³. The low-density polyethylene can have a melt index (MI) according to ASTM D 1238, condition E (190° C. at 2.16 kg) ranging from 0.1 to 80 g/10 min., and preferably ranges from about 1 to 10 g/10 min, as well as can have a density according to ASTM D 1505 ranging from 0.910 g/cm³ to 0.940 g/cm³. The linear low-density polyethylene can have a melt index (MI) according to ASTM D 1238, condition E (190° C. at 2.16 kg) ranging from 0.1 to 150 g/10 min., and preferably ranges from about 1 to 10 g/10 min, as well as can have a density according to ASTM D 1505 ranging from about 0.915 g/cm³ to about 0.925 g/cm³. Non-limiting examples of preferred polyethylene compositions include Alathon® M5370WC and Alathon® 6080WC available from Equistar Chemicals, LP.

In preferred embodiments, the polyethylene compositions of the present subject matter preferably have a barefoot dissipation factor of less than 5.0×10⁻⁵, preferably less than 4.0×10⁻⁵, and most preferably less than 3.0×10⁻⁵ at 2 GHz, wherein the barefoot dissipation factor is determined using the polyethylene compositions without any additives, and by the test method listed below. In particularly preferred embodiments, the polyethylene compositions of the present subject matter can have a barefoot dissipation factor equal to, or less than, 2.5×10⁻⁵ at 2 GHz, wherein the barefoot dissipation factor is determined using the polyethylene compositions without any additives, and by the test method listed below.

Moreover, in preferred embodiments, since the polyethylene compositions comprising about 0.0001% to less than 0.22% by weight of the polar phenolic antioxidant according to the present subject matter can have varying initial dissipation factor values depending upon a variety of variables, including initial oxidation levels and initial polar impurity levels within the material, the polyethylene compositions can have a reduced normalized dissipation factor that correlates to the following equation at 2 GHz:

DF_{PE}=−3.8×10⁻⁴*PPAₚₚₘ+(1±0.55)

wherein DF_{PE} is the normalized dissipation factor of the polyethylene composition, with the normalized dissipation factor being normalized with respect to a value of 1.0, and PPAₚₚₘ is the amount of the polar phenolic antioxidant present within the polyethylene composition in parts per million (ppm). Furthermore, generally in preferred embodiments, the polyethylene compositions can have a reduced dissipation factor that ranges from about 5×10⁻⁶ to about 3×10⁻⁵ at 2 GHz, and preferably ranges from about 7.50×10⁻⁶ to about 2.75×10⁻⁵ at 2 GHz. In particularly preferred embodiments, the polyethylene compositions can have a reduced dissipation factor that ranges from about 8.8×10⁻⁶ to about 2.5×10⁻⁵ at 2 GHz.

Since the polyethylene compositions of the present subject matter have a reduced dissipation factor versus the same polyethylene compositions comprising less of the same polar phenolic antioxidant, and as such, have better attenuation properties at higher frequencies, the polyethylene compositions can be used in a variety of cable and wire insulating applications. Insulating applications can include, but are not limited to wire sheathes and covers, cable sheathes and covers, and insulating material for cable applications, as well as discs and spacers for air core cables. In particularly preferred embodiments, the polyethylene compositions of the present subject matter can be used in insulating applications for coaxial cables, including high-frequency coaxial cables, such as coaxial cables for use at frequencies equal to or higher than 1 GHz, and preferably equal to or higher than 2 GHz.

Method for Reducing the Dissipation Factor of Polyethylene Compositions:

The methodology for reducing the dissipation factor for polyethylene compositions of the present subject matter can be performed in a variety of ways. Generally, the dissipation factor of a polyethylene composition can be reduced by adding about 0.0001% to less than 0.22% by weight of a polar phenolic antioxidant of the present subject matter to the polyethylene composition, with the polyethylene composition comprising a reduced dissipation factor versus the same polyethylene composition comprising less of the same polar phenolic antioxidant. In particular, the dissipation factor of a polyethylene composition can be reduced by adding a polar phenolic antioxidant of the present subject matter to the polyethylene composition, the polyethylene composition comprising some initial amount of the polar phenolic antioxidant, wherein the initial amount is less than a total amount of about 0.0001% to less than 0.22% by weight, with the polyethylene composition comprising a total amount of about 0.0001% to less than 0.22% by weight of the polar phenolic antioxidant after the additional polar phenolic antioxidant has been added, and the polyethylene composition comprises a reduced dissipation factor versus the same polyethylene composition comprising less of the same polar phenolic antioxidant. In a particularly preferred embodiment of the present subject matter, the dissipation factor of a polyethylene composition can be reduced by adding a polar phenolic antioxidant of the present subject matter to the polyethylene composition, the polyethylene composition comprising some initial amount of the polar phenolic antioxidant, wherein the initial amount is less than a total amount of about 0.0005% to about 0.16% by weight, with the polyethylene composition comprising a total amount of about 0.0005% to about 0.16% by weight of the polar phenolic antioxidant after the additional polar phenolic antioxidant has been added, and the polyethylene composition comprises a reduced dissipation factor versus the same polyethylene composition comprising less of the same polar phenolic antioxidant. Yet in further preferred embodiments, the dissipation factor of a polyethylene composition can be reduced by adding a polar phenolic antioxidant of the present subject matter to the polyethylene composition, the polyethylene composition comprising some initial amount of the polar phenolic antioxidant, wherein the initial amount is less than a total amount of about 0.02% to about 0.08% by weight, with the polyethylene composition comprising a total amount of about 0.02% to about 0.08% by weight of the polar phenolic antioxidant after the additional polar phenolic antioxidant has been added, and the polyethylene composition comprises a reduced dissipation factor versus the same polyethylene composition comprising less of the same polar phenolic antioxidant.

The polar phenolic antioxidant can be added to the polyethylene composition by a variety of methods well-known to those skilled in the art, including, but not limited to, various compounding techniques. In particular preferred embodiments, the polyethylene composition and the polar phenolic antioxidant are compounded together using a single-screw extruder, a reciprocating single-screw mixer, a twin-screw extruder, or a high-intensity batch or continuous internal mixer.

### Examples

The following examples are illustrative of preferred compositions, and are not intended to be limitations thereon. All percentages are based on the percent by weight of the polyethylene composition prepared, unless otherwise indicated, and all totals equal 100% by weight.

Test Method:

The dissipation factor was determined by loading 251 grams of the high-density polyethylene material for each example into the testing tube of a Hewlett Packard HP 8753E Network Analyzer having a RFS Cablewave Systems P/N 920242 resonance chamber fixture, and analyzing the dissipation factor for each example when a 2 GHz electrical charge was applied to the material.

### Control Examples

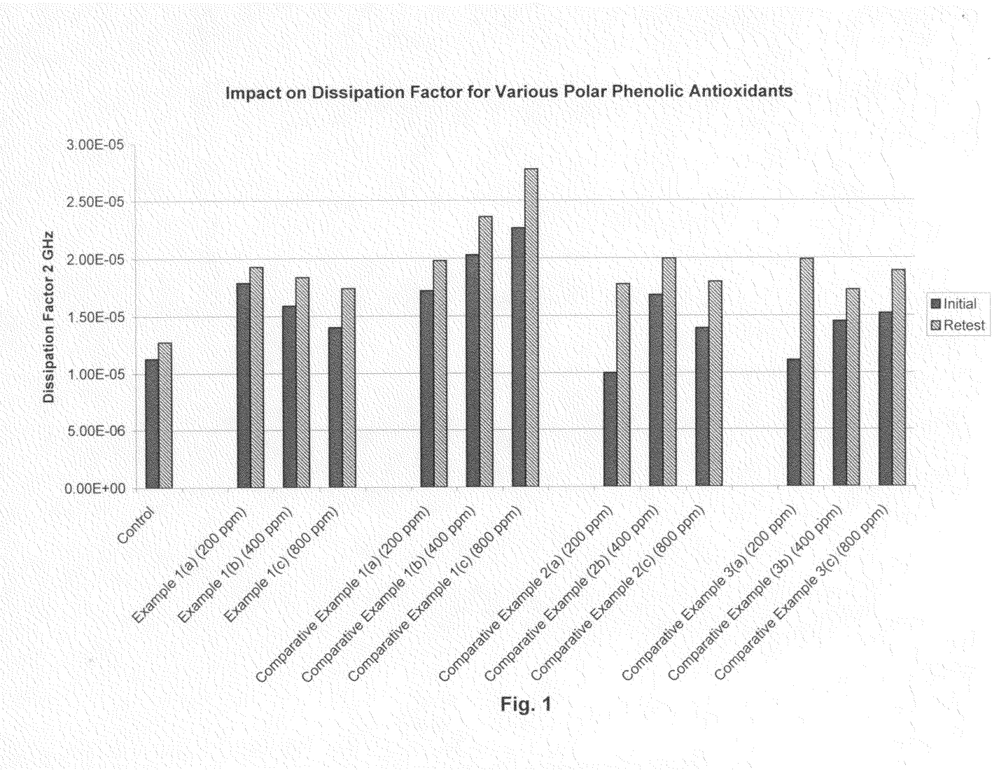

Two Control Examples were produced using a barefoot, high-density polyethylene copolymer resin grade M5370WC, which is an Alathon® resin available from Equistar Chemicals, LP for cable and wire applications. Since both Control Examples are barefoot, no additives were added to the material. As can be seen in FIG. 1, the initial Control Example produced a dissipation factor of 1.13×10⁻⁵ at 2 GHz, while the retest Control Example produced a dissipation factor of 1.27×10⁻⁵ at 2 GHz.

### Examples 1(a)

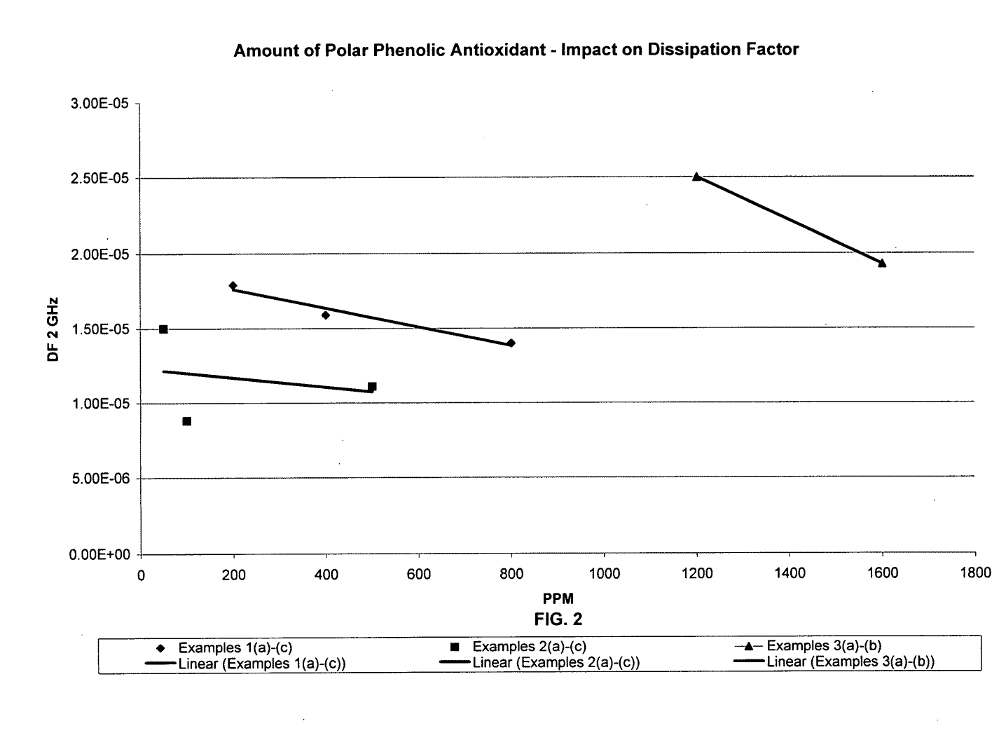

An initial Example 1(a) was produced using the same polyethylene copolymer resin grade as the Control Examples in which 200 ppm (0.02 wt. %) of octadecyl-3-(3,5-di-tert-butyl-4-hydroxyphenyl)-propionate, which is a polar phenolic antioxidant of the present subject matter and is marketed as IRGANOX® 1076 available from Ciba, previously known as Ciba Specialty Chemicals Inc., was added to the polyethylene copolymer resin. The polar phenolic antioxidant was added to the polyethylene copolymer resin by using a single-screw Davis-Standard®, 2.5″, 20:1 L:D extruder. As can be seen in FIGS. 1 and 2, the initial Example 1(a) produced a dissipation factor of 1.79×10⁻⁵ at 2 GHz.

A retest Example 1(a) was produced in the same manner as the initial Example 1(a). As can be seen in FIG. 1, the retest Example 1(a) produced a dissipation factor of 1.93×10⁻⁵ at 2 GHz.

### Examples 1(b)

An initial Example 1(b) was produced in the same manner as the initial Example 1(a); however, 400 ppm (0.04 wt. %) of the polar phenolic antioxidant from the initial Example 1(a) was added to the polyethylene copolymer resin. As can be seen in FIGS. 1 and 2, the initial Example 1(b) produced a dissipation factor of 1.59×10⁻⁵ at 2 GHz.

A retest Example 1(b) was produced in the same manner as the initial Example 1(b). As can be seen in FIG. 1, the retest Example 1(b) produced a dissipation factor of 1.84×10⁻⁵ at 2 GHz.

### Examples 1(c)

An initial Example 1(c) was produced in the same manner as the initial Example 1(a); however, 800 ppm (0.08 wt. %) of the polar phenolic antioxidant from the initial Example 1(a) was added to the polyethylene copolymer resin. As can be seen in FIGS. 1 and 2, the initial Example 1(c) produced a dissipation factor of 1.40×10⁻⁵ at 2 GHz.

A retest Example 1(c) was produced in the same manner as the initial Example 1(c). As can be seen in FIG. 1, the retest Example 1(c) produced a dissipation factor of 1.74×10⁻⁵ at 2 GHz.

### Comparative Examples 1(a)

An initial Comparative Example 1(a) was produced using the same polyethylene copolymer resin grade as the Control Example; however, 200 ppm (0.02 wt. %) of the polar phenolic antioxidant thiodiethylene-bis[3-(3,5-di-tert-butyl-4-hydroxyphenyl)propionate], which is marketed as IRGANOX® 1035 by Ciba, was added to the polyethylene copolymer resin. The polar phenolic antioxidant was added to the polyethylene copolymer resin by using the same single-screw extruder used in Examples 1(a). As can be seen in FIG. 1, the initial Comparative Example 1(a) produced a dissipation factor of 1.72×10⁻⁵ at 2 GHz.

A retest Comparative Example 1(a) was produced in the same manner as the initial Comparative Example 1(a). As can be seen in FIG. 1, the retest Comparative Example 1(a) produced a dissipation factor of 1.98×10⁻⁵ at 2 GHz.

### Comparative Examples 1(b)

An initial Comparative Example 1(b) was produced in the same manner as the initial Comparative Example 1(a); however, 400 ppm (0.04 wt. %) of the polar phenolic antioxidant from the initial Comparative Example 1(a) was added to the polyethylene copolymer resin. As can be seen in FIG. 1, the initial Comparative Example 1(b) produced a dissipation factor of 2.03×10⁻⁵ at 2 GHz.

A retest Comparative Example 1(b) was produced in the same manner as the initial Comparative Example 1(b). As can be seen in FIG. 1, the retest Comparative Example 1(b) produced a dissipation factor of 2.36×10⁻⁵ at 2 GHz.

### Comparative Examples 1(c)

An initial Comparative Example 1(c) was produced in the same manner as the initial Comparative Example 1(a); however, 800 ppm (0.08 wt. %) of the polar phenolic antioxidant from the initial Comparative Example 1(a) was added to the polyethylene copolymer resin. As can be seen in FIG. 1, the initial Comparative Example 1(c) produced a dissipation factor of 2.26×10⁻⁵ at 2 GHz.

A retest Comparative Example 1(c) was produced in the same manner as the initial Comparative Example 1(c). As can be seen in FIG. 1, the retest Comparative Example 1(c) produced a dissipation factor of 2.77×10⁻⁵ at 2 GHz.

### Comparative Examples 2(a)

An initial Comparative Example 2(a) was produced using the same polyethylene copolymer resin grade as the Control Example; however, 200 ppm (0.02 wt. %) of the polar phenolic antioxidant 1,2-bis(3,5-di-tert-butyl-4-hydroxyhydrocinnamoyl)hydrazine, which is marketed as IRGANOX® 1024 by Ciba, was added to the polyethylene copolymer resin. The polar phenolic antioxidant was added to the polyethylene copolymer resin by using the same single-screw extruder used in Examples 1(a). As can be seen in FIG. 1, the initial Comparative Example 2(a) produced a dissipation factor of 1.00×10⁻⁵ at 2 GHz, which seems to be slightly lower than expected.

A retest Comparative Example 2(a) was produced in the same manner as the initial Comparative Example 2(a). As can be seen in FIG. 1, the retest Comparative Example 2(a) produced a dissipation factor of 1.77×10⁻⁵ at 2 GHz, which seems to be more of a representative result.

### Comparative Examples 2(b)

An initial Comparative Example 2(b) was produced in the same manner as the initial Comparative Example 2(a); however, 400 ppm (0.04 wt. %) of the polar phenolic antioxidant from the initial Comparative Example 2(a) was added to the polyethylene copolymer resin. As can be seen in FIG. 1, the initial Comparative Example 2(b) produced a dissipation factor of 1.68×10⁻⁵ at 2 GHz.

A retest Comparative Example 2(b) was produced in the same manner as the initial Comparative Example 2(b). As can be seen in FIG. 1, the retest Comparative Example 2(b) produced a dissipation factor of 2.00×10⁻⁵ at 2 GHz.

### Comparative Examples 2(c)

An initial Comparative Example 2(c) was produced in the same manner as the initial Comparative Example 2(a); however, 800 ppm (0.08 wt. %) of the polar phenolic antioxidant from the initial Comparative Example 2(a) was added to the polyethylene copolymer resin. As can be seen in FIG. 1, the initial Comparative Example 2(c) produced a dissipation factor of 1.39×10⁻⁵ at 2 GHz.

A retest Comparative Example 2(c) was produced in the same manner as the initial Comparative Example 2(c). As can be seen in FIG. 1, the retest Comparative Example 2(c) produced a dissipation factor of 1.79×10⁻⁵ at 2 GHz.

### Comparative Examples 3(a)

An initial Comparative Example 3(a) was produced using the same polyethylene copolymer resin grade as the Control Example; however, 200 ppm (0.02 wt. %) of the polar phenolic antioxidant tetrakis-(methylene-(3,5-di-tert-butyl-4-hydrocinnamate)methane), which is marketed as IRGANOX® 1010 by Ciba, was added to the polyethylene copolymer resin. The polar phenolic antioxidant was added to the polyethylene copolymer resin by using the same single-screw extruder used in Examples 1(a). As can be seen in FIG. 1, the initial Comparative Example 3(a) produced a dissipation factor of 1.11×10⁻⁵ at 2 GHz.

A retest Comparative Example 3(a) was produced in the same manner as the initial Comparative Example 3(a). As can be seen in FIG. 1, the retest Comparative Example 3(a) produced a dissipation factor of 1.99×10⁻⁵ at 2 GHz.

### Comparative Examples 3(b)

An initial Comparative Example 3(b) was produced in the same manner as the initial Comparative Example 3(a); however, 400 ppm (0.04 wt. %) of the polar phenolic antioxidant from the initial Comparative Example 3(a) was added to the polyethylene copolymer resin. As can be seen in FIG. 1, the initial Comparative Example 3(b) produced a dissipation factor of 1.45×10⁻⁵ at 2 GHz.

A retest Comparative Example 3(b) was produced in the same manner as the initial Comparative Example 3(b). As can be seen in FIG. 1, the retest Comparative Example 3(b) produced a dissipation factor of 1.73×10⁻⁵ at 2 GHz.

### Comparative Examples 3(c)

An initial Comparative Example 3(c) was produced in the same manner as the initial Comparative Example 3(a); however, 800 ppm (0.08 wt. %) of the polar phenolic antioxidant from the initial Comparative Example 3(a) was added to the polyethylene copolymer resin. As can be seen in FIG. 1, the initial Comparative Example 3(c) produced a dissipation factor of 1.52×10⁻⁵ at 2 GHz.

A retest Comparative Example 3(c) was produced in the same manner as the initial Comparative Example 3(c). As can be seen in FIG. 1, the retest Comparative Example 3(c) produced a dissipation factor of 1.89×10⁻⁵ at 2 GHz.

As outlined above and demonstrated in FIG. 1, as the amount of various polar phenolic antioxidants that are not of the present subject matter were increased from 200 ppm to 800 ppm, the dissipation factor of the resultant polyethylene compositions generally increased in a stepwise fashion. This trend was expected since the comparative antioxidants contain polar functional groups, which are known to adversely increase the dissipation factor of the resultant polymer material.

Alternatively, as demonstrated in FIG. 1 as the amount of the polar phenolic antioxidant of the present subject matter was increased in Example 1(a) from 200 ppm to 800 ppm in Example 1(c), the dissipation factor unexpectedly decreased by Δ 3.9×10⁻⁵ in the initial Examples 1(a)-(c), and unexpectedly decreased Δ 1.9×10⁻⁶ in the retest Examples 1(a)-(c). Additionally, FIG. 2 also illustrates this point graphing the decline of the dissipation factor for initial Examples 1(a)-(c).

### Example 2(a)

Example 2(a) was produced using the same polyethylene copolymer resin grade as the Control Examples, with 50 ppm (0.005 wt. %) of the same polar phenolic antioxidant used in Examples 1(a)-(c) (i.e., octadecyl-3-(3,5-di-tert-butyl-4-hydroxyphenyl)-propionate) added to the polyethylene copolymer resin. The polar phenolic antioxidant was added to the polyethylene copolymer resin by using the same single-screw extruder used in Examples 1(a). As can be seen in FIG. 2, Example 2(a) produced a dissipation factor of 1.50×10⁻⁵ at 2 GHz.

### Example 2(b)

Example 2(b) was produced in the same manner as Example 2(a); however, 100 ppm (0.01 wt. %) of the polar phenolic antioxidant from Example 2(a) was added to the polyethylene copolymer resin. As can be seen in FIG. 2, Example 2(b) produced a dissipation factor of 8.80×10⁻⁶ at 2 GHz, which seems to be slightly lower than expected.

### Example 2(c)

Example 2(c) was produced in the same manner as Example 2(a); however, 500 ppm (0.05 wt. %) of the polar phenolic antioxidant from Example 2(a) was added to the polyethylene copolymer resin. As can be seen in FIG. 2, Example 2(c) produced a dissipation factor of 1.11×10⁻⁵ at 2 GHz.

### Example 3(a)

Example 3(a) was produced in the same manner as Example 2(a); however, 1200 ppm (0.12 wt. %) of the polar phenolic antioxidant from Example 2(a) was added to the polyethylene copolymer resin. As can be seen in FIG. 2, Example 3(a) produced a dissipation factor of 2.50×10⁻⁵ at 2 GHz.

### Example 3(b)

Example 3(b) was produced in the same manner as Example 3(a); however, 1600 ppm (0.16 wt. %) of the polar phenolic antioxidant from Example 3(a) was added to the polyethylene copolymer resin. As can be seen in FIG. 2, Example 3(b) produced a dissipation factor of 1.93×101⁵ at 2 GHz.

### Comparative Example 4(c)

Comparative Example 4(c) was produced in the same manner as Example 3(a); however, 2200 ppm (0.22 wt. %) of the polar phenolic antioxidant from Example 3(a) was added to the polyethylene copolymer resin. Comparative Example 4(c) produced a dissipation factor of 2.48×10⁻⁵ at 2 GHz (not shown in FIG. 2), which is nearly identical to the dissipation factor of Example 3(a).

As can be seen from FIG. 2, the dissipation factor of the polyethylene material can be reduced by adding a polar phenolic antioxidant of the present subject matter to the material, within a particular weight percentage range.

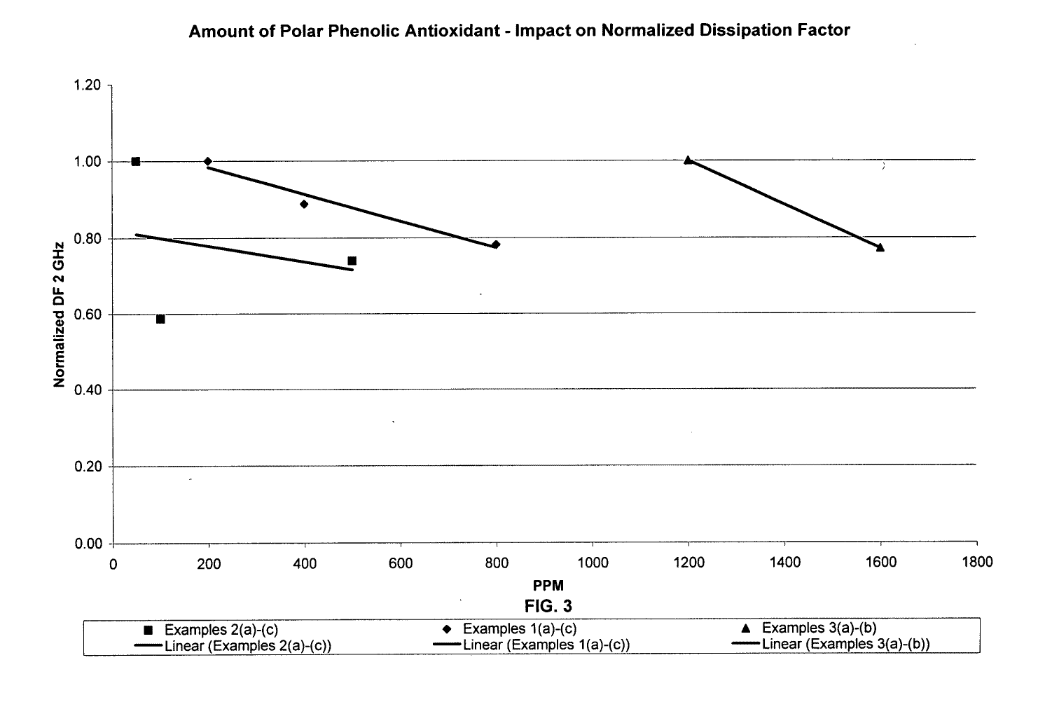

This is further evidenced by FIG. 3, in which the dissipation factors from FIG. 2 were normalized to a value of 1.00 to negate any negative influence from varying initial oxidation levels and varying impurity levels in the starting polyethylene copolymer resin from the different examples. As can be clearly seen, when the three separate examples are all normalized to a starting value of 1.00, the dissipation factor of the polyethylene copolymer resin can be reduced by adding a polar phenolic antioxidant of the present subject matter to the material, within a particular weight percentage range.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

I claim:

1. A polyethylene composition comprising about 0.0001% to less than 0.22% by weight of a polar phenolic antioxidant, the polar phenolic antioxidant comprising a polar phenolic moiety and a non-polar C₃-C₃₀ hydrocarbon moiety, wherein the polyethylene composition comprises a reduced dissipation factor versus the same polyethylene composition comprising less of the same polar phenolic antioxidant.

2. The polyethylene composition of claim 1, wherein the non-polar C₃-C₃₀ hydrocarbon moiety is a linear or branched C₃-C₃₀ alkyl, C₃-C₃₀ alkenyl, C₃-C₃₀ alkynyl, C₃-C₃₀ cycloalkyl group, or C₃-C₃₀ aryl group, the C₃-C₃₀ cycloalkyl group comprising a C₃-C₁₀ cycloalkyl moiety optionally comprising at least one C₁-C₂₇ substituent, and the C₃-C₃₀ aryl group comprising a C₃-C₁₀ aryl moiety optionally comprising at least one C₁-C₂₇ substituent.

3. The polyethylene composition of claim 1, wherein the non-polar C₃-C₃₀ hydrocarbon moiety is selected from a non-polar C₈-C₂₅ hydrocarbon moiety, and the C₈-C₂₅ hydrocarbon moiety is a linear or branched C₈-C₂₅ alkyl, C₈-C₂₅ alkenyl, or C₈-C₂₅ alkynyl.

4. The polyethylene composition of claim 1, wherein the polar phenolic antioxidant is of formula (I): 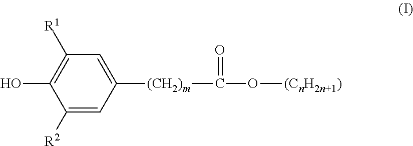
wherein:
R¹ and R² are the same or different, and are selected from linear or branched C₁-C₁₀ aliphatic groups, or C₃-C₁₀ aryl groups, the C₃-C₁₀ aryl groups optionally comprising at least one linear or branched C₁-C₁₀ aliphatic substituent;
m ranges from 1 to 20; and
n ranges from 3 to 30.

5. The polyethylene composition of claim 4, wherein:
R¹ and R² are the same or different, and are selected from a linear or branched C₁-C₁₀ alkyl, C₁-C₁₀ alkenyl, or C₁-C₁₀ alkynyl groups;
m ranges from 1 to 10; and
n ranges from 8 to 25.

6. The polyethylene composition of claim 1, wherein the polar phenolic antioxidant is octadecyl-3-(3,5-di-tert-butyl-4-hydroxyphenyl)-propionate.

7. The polyethylene composition of claim 1 comprising about 0.0005% to about 0.16% by weight of the polar phenolic antioxidant.

8. The polyethylene composition of claim 1 comprising about 0.02% to about 0.08% by weight of the polar phenolic antioxidant.

9. The polyethylene composition of claim 1 wherein the reduced dissipation factor is normalized and correlates to the following equation at 2 GHz:
DF_{PE}=−3.8×10⁻⁴*PPAₚₚₘ+(1±0.55)
wherein:
DF_{PE} is the normalized dissipation factor of the polyethylene composition, the normalized dissipation factor being normalized with respect to a value of 1.0; and
PPAₚₚₘ is the amount of the polar phenolic antioxidant present within the polyethylene composition in parts per million (ppm).

10. The polyethylene composition of claim 1, wherein the reduced dissipation factor ranges from about 5×10⁻⁶ to about 3×10⁻⁵ at 2 GHz.

11. The polyethylene composition of claim 1, wherein the reduced dissipation factor ranges from about 7.50×10⁻⁶ to about 2.75×10⁻⁵ at 2 GHz.

12. The polyethylene composition of claim 1, wherein the reduced dissipation factor ranges from about 8.8×10⁻⁶ to about 2.5×10⁻⁵ at 2 GHz.

13. A cable or wire comprising a polyethylene composition comprising about 0.0001% to less than 0.22% by weight of a polar phenolic antioxidant, the polar phenolic antioxidant comprising a polar phenolic moiety and a non-polar C₃-C₃₀ hydrocarbon moiety, wherein the cable or wire comprises a reduced dissipation factor versus the same cable or wire comprising less of the same polar phenolic antioxidant.

14. The cable or wire of claim 12, wherein the cable or wire is a coaxial cable.

15. The cable or wire of claim 12, wherein the polar phenolic antioxidant is added in an amount of about 0.0005% to about 0.16% by weight.

16. A method for reducing the dissipation factor of a polyethylene composition comprising adding about 0.0001% to less than 0.22% by weight of a polar phenolic antioxidant to the polyethylene composition, the polar phenolic antioxidant comprising a polar phenolic moiety and a non-polar C₃-C₃₀ hydrocarbon moiety, wherein the polyethylene composition comprises a reduced dissipation factor versus the same polyethylene composition comprising less of the same polar phenolic antioxidant.

17. The method of claim 15, wherein the polar phenolic antioxidant is added in an amount of about 0.0005% to about 0.16% by weight.
